(19) United States
(12) Patent Application Publication
(10) Pub. No.: US 2026/0348752 A1
(43) Pub. Date: Nov. 5, 2026

(54) ELUENT LEVEL SENSOR

(71) Applicants: THERMO FISHER SCIENTIFIC INDIA PRIVATE LIMITED, Hyderabad (IN); DIONEX CORPORATION, Sunnyvale, CA (US)

(72) Inventors: Husam Al-Esawi, El Dorado Hills, CA (US); Gary Gleave, Pleasanton, CA (US); Andres Honegger, Pleasanton, CA (US); Ravi Kanth Vadlapudi, Hyderabad (IN); Gaffar Mohammed, Patancheru (IN); Vivek R. Patil, Hyderabad (IN)

(21) Appl. No.: 19/486,671

(22) PCT Filed: May 17, 2024
(86) PCT No.: PCT/US2024/029924

§ 371 Date: Nov. 21, 2025

(30) Foreign Application Priority Data
May 23, 2023 (IN) 202321035753

(51) Int. Cl. G01F 23/20; B01D 15/42; G01G 3/142

(52) U.S. Cl. CPC G01F 23/205; G01G 3/142; B01D 15/424

(57) ABSTRACT

Systems and methods taught herein provide an eluent level sensor that enables real-time monitoring of the level of eluent or waste liquid in a container placed on the eluent level sensor. The eluent level sensor alerts the user when the eluent liquid level is below or above a selectable threshold as appropriate to the particular contents of the container. For example, the eluent level sensor can alert the user when the eluent liquid level falls below the selectable threshold for a container holding new eluent or eluent precursor. In the eluent delivery systems, as the user is alerted before the container is empty, it helps the user to save a lot of analysis time and effort. By giving notification (e.g., visual notification) to the user of the eluent level, the eluent level sensor can avoid damage to instrumentation and improve user experience.

### BACKGROUND

In liquid measurement systems and various chromatography applications, the end user supplies eluents that are flushed through the column. Additionally, some output fluids are collected as waste. Containers of eluent are refilled or replaced by the end user as eluent is used, and containers of waste are emptied or replaced with empty containers as the containers are filled.

### BRIEF SUMMARY

The technical field of the present disclosure is analytical instruments and applications. This device can be used in all liquid chromatography applications where there is requirement for delivering liquid and collecting the analyzed liquid or waste outputs.

Provided herein is an eluent level sensor. The eluent level sensor includes one or more sensors to measure a weight of a container placed upon the eluent level sensor. The eluent level sensor includes a microcontroller to receive and process signals from the one or more sensors. The microcontroller is configured to set an alert status if the signals from the one or more sensors indicate that an amount of liquid in the container has passed a threshold value.

Provided herein is a method of automatically measuring a liquid level in a container for use with a chromatography system. The method includes placing a container on an eluent level sensor. The eluent level sensor includes one or more sensors to measure a weight of a container placed upon the eluent level sensor and a microcontroller to receive and process signals from the one or more sensors. The method further includes measuring a liquid amount in the container based on the signals from the one or more sensors using the microcontroller. The method further includes alerting a user when the liquid amount has passed a threshold value.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a perspective view of an eluent level sensor in accordance with various embodiments taught herein.

FIG. 1B illustrates an exploded view of the eluent level sensor of FIG. 1A.

FIG. 2A illustrates a sensor tray according to some embodiments taught herein.

FIG. 2B illustrates a top view of an alternative design for the sensor tray according to some embodiments taught herein.

FIG. 2C illustrates a bottom view of the sensor tray of FIG. 2B according to some embodiments taught herein.

FIG. 3 illustrates an example sensor tray according to one embodiment of the present disclosure.

FIG. 4A illustrates a top perspective view of the top cover in accordance with one embodiment.

FIG. 4B illustrates a bottom perspective view of the top cover in accordance with one embodiment.

FIG. 4C illustrates a cross-sectional view of the top cover in accordance with some embodiments taught herein.

FIG. 5 illustrates a partial cross-sectional view of a portion of the eluent level sensor as taught in various embodiments herein.

FIG. 6A illustrates a light cap according to some embodiments described herein.

FIG. 6B illustrates an example light cap in accordance with some embodiments described herein.

FIG. 7 illustrates an underside of an example bottom plate in accordance with some embodiments.

FIG. 8 illustrates an underside of a partially-constructed eluent level sensor including the top cover and bottom plate.

FIG. 9 illustrates an example cover plate in accordance with some embodiments taught herein.

FIG. 10 illustrates the underside of the assembled eluent level sensor according to some embodiments taught herein.

FIG. 11 illustrates the assembled eluent level sensor including light cap.

FIG. 12 illustrates an example electrical connection diagram for the eluent level sensor according to some embodiments taught herein.

FIG. 13 illustrates a schematic view of electrical connections between four sensors in some embodiments taught herein.

FIG. 14 illustrates a networked sensing environment that includes multiple eluent level sensors connected to an external computing device in the form of an analysis system in accordance with some embodiments taught herein.

FIG. 15A illustrates embodiments of eluent level sensors as taught herein holding containers.

FIG. 15B illustrates two eluent level sensors that are stored in an instrument tray for a chromatography instrument.

FIG. 16 illustrates a flowchart for a method of automatically measuring liquid levels in a container for use with chromatography systems.

### DETAILED DESCRIPTION

Systems and methods taught herein provide an eluent level sensor that enables real-time monitoring of the level of eluent in a container placed onto the eluent level sensor. The eluent level sensor alerts the user when the eluent liquid level is below or above a selectable threshold as appropriate to the particular contents of the container. For example, the eluent level sensor can alert the user when the eluent liquid level falls below the selectable threshold for a container holding new eluent or eluent precursor. In the eluent delivery systems, as the user is alerted before the container is empty, it helps the user to save a lot of analysis time and effort. Moreover, running out of eluent during system operation can cause irreversible damage to the expensive columns in any chromatography system or loss of precious samples or data. By giving notification (e.g., visual notification) to the user of the current eluent level, the eluent level sensor can avoid damage to instrumentation and improve user experience. By communicating liquid availability status via the eluent level sensor, an analytical pump of the associated chromatography instrument can be halted to avoid the pump from running idly dry, thereby increasing the lifespan of the pump and its seals.

In other embodiments, the eluent level sensor can alert the user when the eluent liquid level rises above the selectable threshold for a container holding waste output. During operation of a chromatography system, waste fluid can be collected in a container. If attention is not paid to the eluent liquid level in the waste container, the container can overflow/overspill, which can create subsequent cleaning issues or delay operation of the machine while additional waste cannot be added to the container. Eluent level sensors taught herein can notify the user of the waste eluent liquid level so that the waste may be timely removed. In some cases, eluent level sensors taught herein can provide an early indication to the user of excessive eluent wastage that can arise when there is a leak in the plumbing of the entire system. For example, an eluent level sensor corresponding to a container and an eluent level sensor corresponding to a waste container can communicate directly with one another or through an external computing device. Discrepancies between the reducing measured fluid levels (e.g., reduced weight) of the eluent container and the increasing measured fluid levels of the waste container may indicate that leakage has occurred. Alternatively or in addition, the external computing device may compare the measured rate of change of liquid levels (e.g., by weight or by volume) for the eluent container and the waste container to each other or to a desired flow rate to identify one or more leakage conditions such as presence or absence of leakage or degree or severity of leakage (for example, by measuring discrepancies).

The eluent level sensor taught herein can be used to monitor liquid in source bottles or in drain bottles (i.e., bottles that collect the analyzed fluids) so that the user is alerted when the waste liquid level is more than the maximum specified threshold such as a maximum capacity. As described in further detail below, the user can set the thresholds and other parameters in a graphical user interface of an external computing device that is connected using an interface or protocol (e.g., USB) to the eluent level sensor. The eluent level sensor can provide light or color visual feedback directly to the user to alert the user of bottle fluid level status. In some embodiments, the eluent level sensors can use a proprietary communication protocol with the targeted host (e.g., external computing device) to provide control and to report the liquid level data.

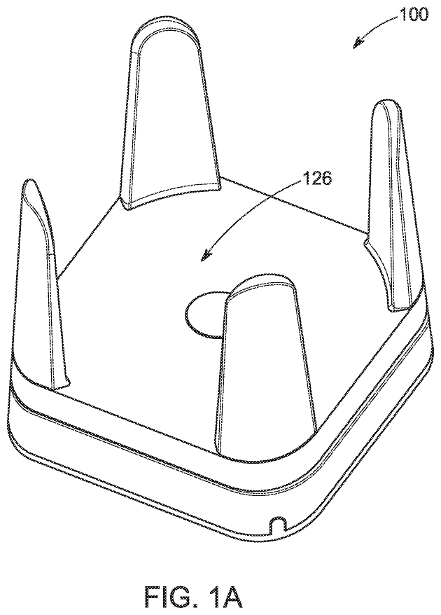

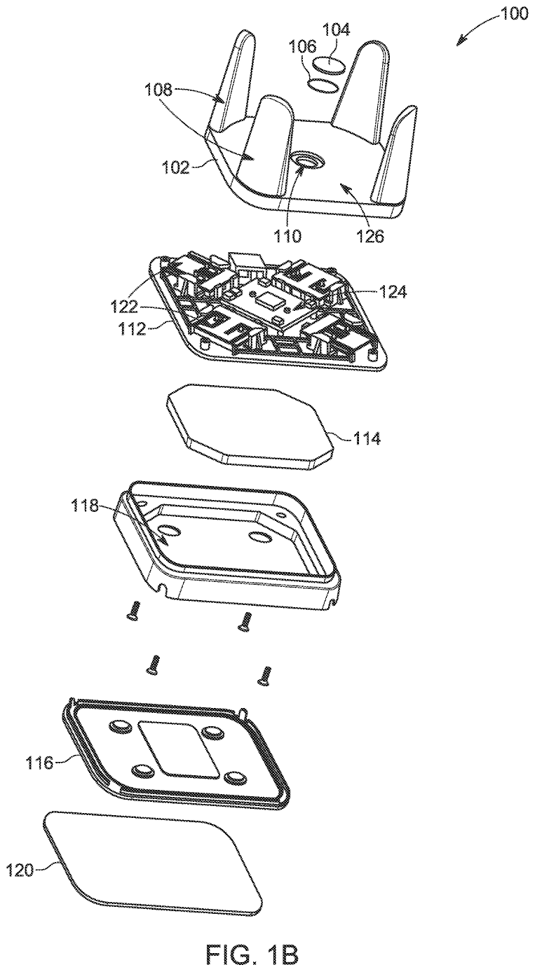

FIG. 1A and FIG. 1B illustrate, respectively, a perspective view and an exploded view of the eluent level sensor 100 in accordance with some embodiments taught herein.

The eluent level sensor 100 includes a top cover 102, a sensor tray 112, an internal block 114, a bottom plate 116, and a cover plate 120. The sensor tray 112 can include sensors 122 and a circuit board 124. When a container is placed onto the top cover 102, the eluent level sensor 100 can measure the level of liquid within the container using a measured weight of the combined liquid and container and stored knowledge about the type of liquid. When the measured level of eluent is below a pre-determined threshold value (for new eluent) or above a predetermined threshold value (for waste liquid), the eluent level sensor 100 can notify the user through visual indicators upon the eluent level sensor 100 itself, through communication from the circuit board 124 to an external computing system, or both. As used herein, “level” of a fluid can refer to the height of a top surface of a fluid volume above a baseline and can also refer to other general representations of fluidic amounts such as total volume, exposed surface area, weight of fluid, or mass of fluid.

In some embodiments, the eluent level sensor 100 can accept a wide range of containers having various sizes and shapes for measurement and is not limited to accepting a particular size or shape of container. For example, the eluent level sensor 100 can accept containers in any form including glass bottles, plastic bottles, or other suitable containers. In some embodiments, the eluent level sensor 100 can accept eluent bottles that hold within a range of 100 mL to 100,000 mL of fluid. The eluent level sensor can advantageously measure accurately the volume of any liquid in any container placed on it.

The eluent level sensor can intelligently measure the weight of the entire container including liquid and can communicate the liquid level to an analysis system (described in greater detail below). In some embodiments, the eluent level sensor works on a load cell principle wherein multiple load cells are connected in an electronic bridge style to measure the total weight. Once the liquid level falls below or goes above the threshold (depending on the particular application), the eluent level sensor can set an alert status and communicate the alert status to the analysis system. The eluent level sensor can alert the user to changes in the liquid levels by providing an illuminating status color (through visual indicators described below) to any translucent bottle from green to red indicating the warning to the user. The external computing device conveys the alert information to the user and/or other systems to take corresponding actions. When the eluent is replenished in the delivery system or emptied in the waste system, the eluent level sensor can set a “ready” status (i.e., remove “alert” status) and the visual indicator can be set to a ready state (e.g., changing color red to green).

In some embodiments, the eluent level sensor 100 is portable and can be moved or placed upon any surface on or around an associated chromatography instrument to which eluent is being supplied or from which waste is being drained. In some conventional chromatography instruments, liquid container holders are positioned atop a cabinet or rack that contains the chromatography instrument. This location can present difficulties in accessing for shorter users and can present difficulties in lifting heavy liquid-filled containers to rest atop the cabinet. Eluent level sensors 100 according to some embodiments of the present disclosure can advantageously be placed at different locations apart from (i.e., not in contact with) the chromatography instrument and/or can be moved after initial placement to provide ease of access.

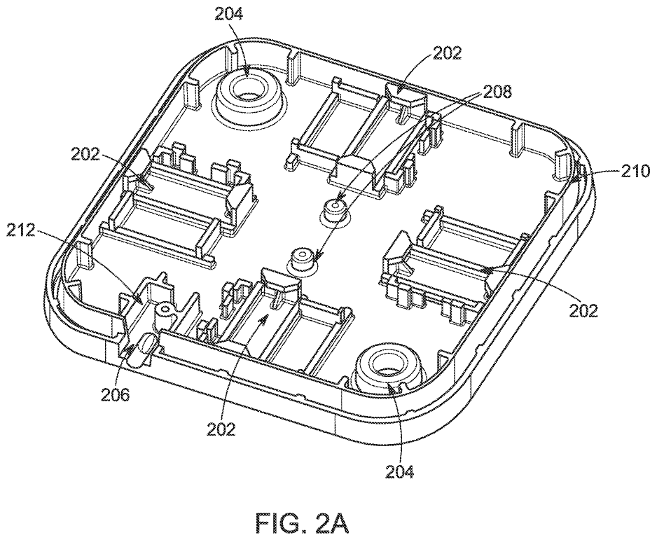

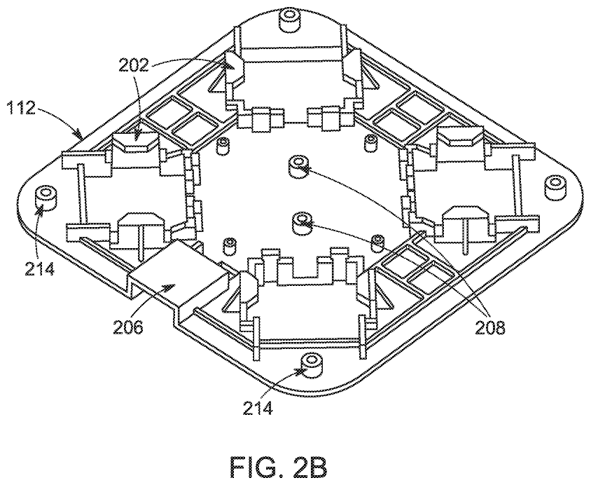

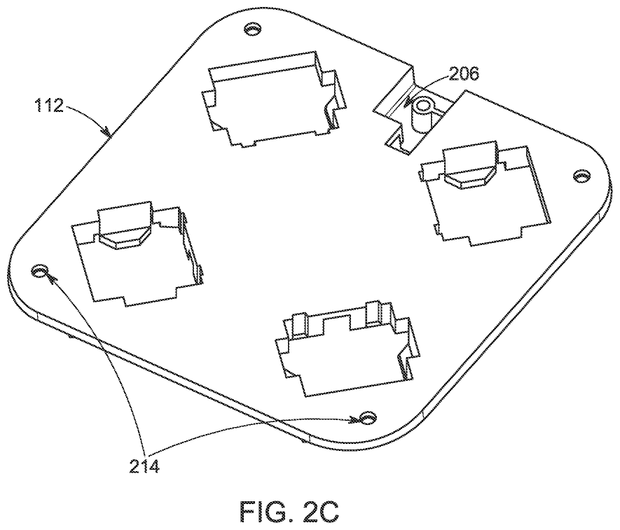

FIG. 2A illustrates the sensor tray 112 according to some embodiments described herein. The sensor tray 112 includes one or more cover mounts 204, one or more sensor mounts 202, an electrical passthrough 206, one or more circuit board mounts 208, and a ridge 210. The cover mounts 204 enable proper orientation and positioning of the top cover 102 during attachment of the top cover 102 to the sensor tray 112. For example, the cover mount 204 can include a latched or friction-fit part such as an aperture that mates with a compatible object such as a peg on the top cover 102. In other embodiments, the cover mount 204 includes an aperture to receive a threaded portion of a peg therethrough whereby a nut or other securing mechanism can be attached to the threaded portion on a backside of the sensor tray 112. The sensor mount 202 retains a sensor 122 in place below the cover to enable measurement of quantities (e.g., weight) of objects placed on the top cover. In some embodiments, the sensor mount 202 holds the sensor 122 at the proper height above the sensor tray 112 to contact an underside of the top cover 102. The sensor 122 thereby receives the weight of objects through contact with the top cover 102.

The circuit board mounts 208 enable sturdy connection of a circuit board 124 to the sensor tray 112. For example, the circuit board mounts 208 can include holes or apertures to receive screws, bolts, or other fasteners placed on or through the circuit board 124. The electrical passthrough 206 provides a path for power cables, communications cables, or both to connect the circuit board 124 with external power sources or external computing devices. A strain relief 212 can be provided adjacent to the electrical passthrough 206 through which electrical cables pass. The strain relief 212 can help to prevent damage to the eluent level sensor 100 if a sudden force is applied to electrical cables (e.g., if a user trips on the electrical cable or if the device falls from a shelf). The strain relief 212 can hold the electrical cable in place to prevent transmission of the force on a pulled cable to the circuit board 124.

In various embodiments, the sensor tray 112 can include a single piece of molded material or multiple pieces of material that are attached to one another. The sensor tray 112 can include a ridge 210 that contacts a complementary surface on the top cover. In some embodiments, the ridge 210 can create a seal against the top cover to prevent fluid ingress into the interior of the eluent level sensor. In some embodiments, the sensor tray 112 can be formed by molding or extrusion processes. The sensor tray 112 can include amorphous or semi-crystalline polymer materials such as poly butylene terephthalate (PBT), polyethylene terephthalate (PET), and these or other polymer materials blended with polycarbonate (PC). In some embodiments, the material can include resin under the trade name of Valox™.

FIG. 2B illustrates a top view of an alternative design for the sensor tray 112 according to some embodiments taught herein. The sensor tray 112 can include sensor mounts 202, circuit board mounts 208, electrical passthrough 206, and mount holes 214. The mount holes 214 enable the sensor tray 112 to be removably affixed to the bottom plate 116 in some embodiments. In this sensor tray 112, the sensor mounts 202 are placed close to the corners of the sensor tray 112 whereas the sensor mounts 202 were placed roughly equidistant from corners of the sensor tray 112 of FIG. 2A.

FIG. 2C illustrates a bottom view of the sensor tray of FIG. 2B according to some embodiments taught herein. The electrical passthrough 206 is shown to be a small housing embedded in the sensor tray 112 to route or aggregate electrical cables as they leave the sensor tray 112.

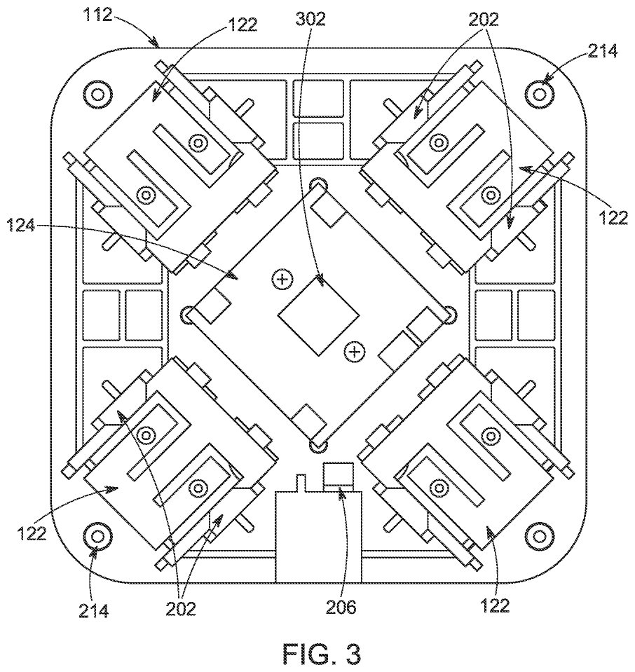

FIG. 3 illustrates one embodiment of the sensor tray 112 according to the present disclosure. The depicted sensor tray 112 includes four sensors 122, the circuit board 124, and the electrical passthrough 206 enabling connection of the circuit board to external power and external computing devices or external communications devices.

The sensors 122 can include any suitable sensor that provides measurable output in response to the application of weight, strain, or stress. Examples of suitable sensors include resistive gauges, capacitive strain gauges, and strain gauge load cells. In some embodiments, the sensors 122 are connected directly or indirectly to a microcontroller as described in more detail below. The circuit board 124 can be a printed circuit board in some embodiments.

The circuit board 124 can include a visual indicator 302 in some embodiments. The visual indicator 302 can provide a visible signal (such as presence or absence of light or colors of light) to the user to indicate the status of sensing the amount of liquid in the container placed upon the eluent level sensor. For example, the visual indicator 302 can illuminate (i.e., emit light) when the level of liquid in the container is such that the user should take further action to empty, refill, or replace the container but remain unilluminated when conditions are acceptable. In other embodiments, the visual indicator 302 can emit red light when the level of liquid in the container is such that the user should take further action to empty, refill, or replace the container while emitting green light when conditions are acceptable and the user does not need to take further action. It will be understood that the visual indicator 302 can include a single light emitter or other signaling device or multiple light emitters or signaling devices in various embodiments. In some embodiments, the visual indicator 302 can include one or more light emitting diodes (LEDs).

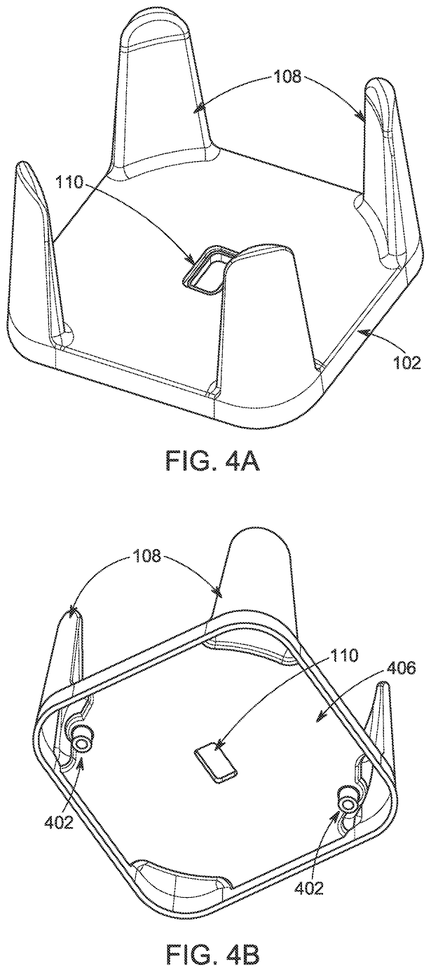

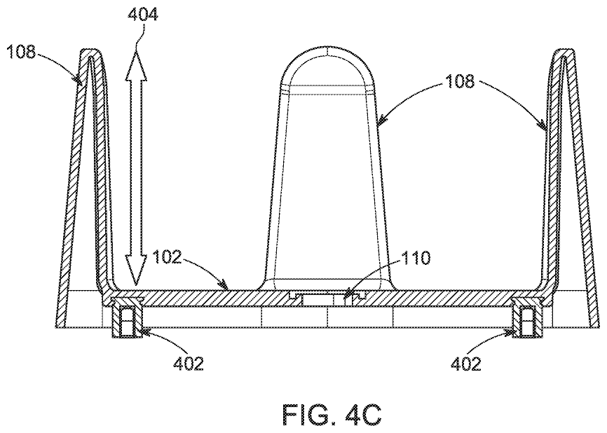

FIG. 4A illustrates a top perspective view of the top cover 102. The top cover 102 includes one or more corner guides 108 to facilitate positioning of containers atop the top cover 102. In some embodiments, the corner guides 108 are at least partially hollow such that they are shell-like. By providing hollow corner guides 108, the top cover 102 can be manufactured using Design for Manufacturing (DFM) principles. In other embodiments, the corner guide 108 can be solid material pieces (i.e., not hollow). In various embodiments, a top surface 126 of the top cover 102 can have an area in a range from 10 to 30 square inches. The corner guides of the top cover assist the user in properly locating the container at a center of the top surface 126. The corner guides assist in capturing and holding containers in their upright position and give the user easier visibility when placing the bottles or containers into the center of the top cover.

In some embodiments, the top cover 102 can be formed by molding or extrusion processes. The top cover 102 can include amorphous or semi-crystalline polymer materials such as poly butylene terephthalate (PBT), polyethylene terephthalate (PET), and these or other polymer materials blended with polycarbonate (PC). In some embodiments, the material can include resin under the trade name of Valox™.

FIG. 4B illustrates a bottom perspective view of the top cover 102. The partially hollow corner guides 108 can be seen in this view as well as the pegs 402. The pegs 402 can include an internally or externally threaded portion that is couplable to a complementary bolt or nut to allow the top cover 102 to be removably fastened to the sensor tray 112. In some embodiments, the pegs 402 can be overmolded to increase the friction between the peg and the cover mount 204 of the sensor tray 112 to more securely hold the top cover 102 to the sensor tray 112. In some embodiments, the thickness of the overmolding on the pegs 402 can be selected based upon an expected size or weight of container. For example, the thickness of the overmolding can be selected as twice as thick for an eluent level sensor adapted for 4-liter bottles than for an eluent level sensor adapted for 2-liter bottles.

FIG. 4C illustrates a cross-sectional view of the top cover 102. In some embodiments, a height 404 of the corner guide 108 (e.g., as measured from a base level to the tip of the corner guide) can be selected based upon the type of container that the eluent level sensor is adapted to measure. In some embodiments, the height 404 can be in a range from 1 inch to 5 inches or in an a range from 2 inches to 3 inches.

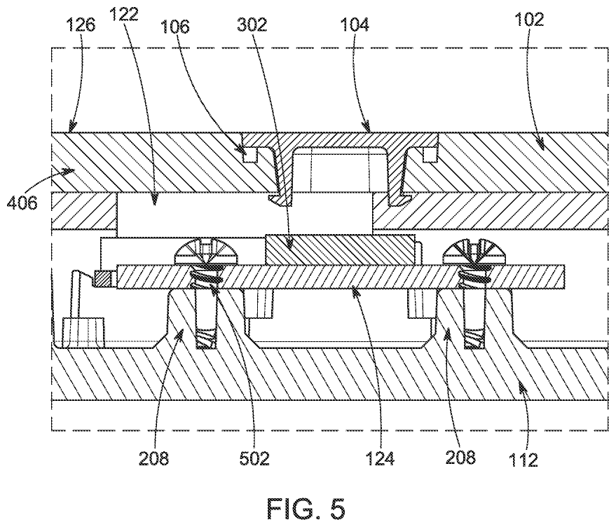

FIG. 5 illustrates a partial cross-sectional view of a portion of the eluent level sensor as taught in various embodiments herein. In this view, the cross-section has been taken along a line connecting two circuit board mounts 208 as shown, for example, in FIG. 2A. Thus, the sensor 122 is in the “background” in this view. The bottom surface 406 of the top cover 102 directly contacts the sensor 122.

The light cap 104 can be formed wholly or partially of optically transparent material. For example, the light cap 104 can be formed of a clear plastic in some embodiments. The light cap 104 can be permanently or removably mounted into the opening 110 in the top cover 102. In some embodiments, the light cap 104 is aligned with the visual indicator 302 such that light emitted from the visual indicator 302 can pass through the light cap 104 and be visible to a user external to the eluent level sensor 100. For example, the light can indicate the alert status (e.g., “ready” or “alert/not ready”) by intensity or color visual feedback conveyed through the container when the container is transparent. In other words, the visual indicator 302 can illuminate the entire container so that a user can tell, at a glance and from a distance away, whether the eluent level sensor is ready or whether a container needs maintenance (e.g., removal of waste or provision of additional eluent). In some embodiments, the light cap 104 includes a ridge or ledge to hold a seal 106 that provides sealing between the light cap 104 and opening 110. The seal can prevent fluids such as eluent from passing through the opening 110 and damaging the internal components of the eluent level sensor such as the circuit board 124. In other embodiments, the seal 106 can be placed into a recess within the top surface 126 of the top cover 102. In some embodiments, the seal 106 can include a physical obstruction such as a rubber o-ring (or o-ring made of different polymer materials), adhesives such as silicone glue, or a combination of physical obstructions and adhesives. In some embodiments, the seal 106 can be omitted as the friction fit between the light cap 104 and opening 110 is sufficient to prevent ingress of water. The light cap 104 and corresponding opening 110 in the top cover 102 can have any suitable shape as viewed from overhead including circular, ovular, rectangular (with or without rounded corners), or other shapes.

The circuit board 124 can be connected to the circuit board mounts 208 of the sensor tray 112 using fasteners 502. For example, the fasteners 502 can include screws, adhesive, or other suitable means.

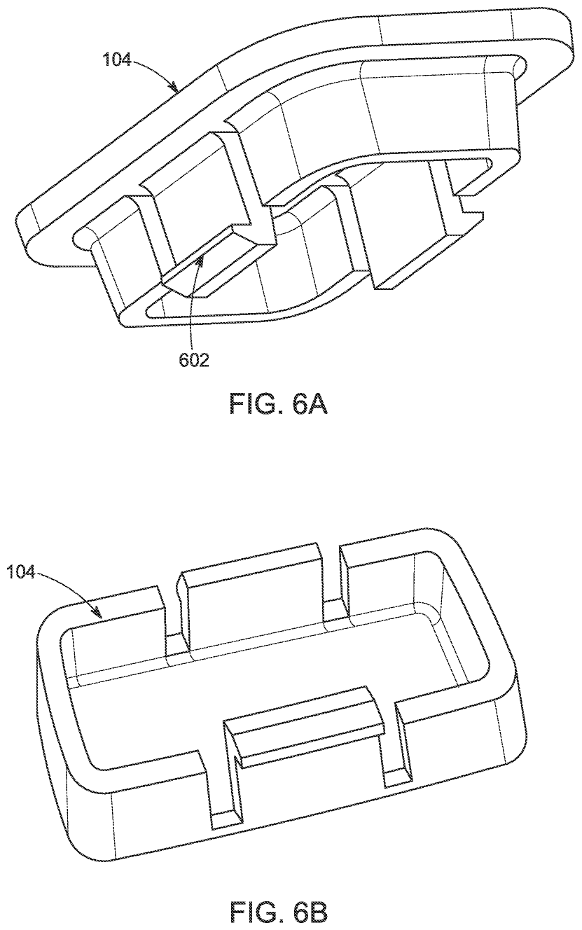

FIG. 6A illustrates the light cap 104 according to some embodiments described herein. The light cap can include one or more engagement mechanisms 602 that engage with the opening 110 of the top cover 102 to secure the light cap 104 to the top cover 102. For example, the engagement mechanism 602 can include one or more clips or hooks that have resilient properties such that they can be compressed to pass through the opening 110 before rebounding to their original shape to prevent removal of the light cap from the opening 110. In some embodiments, the engagement mechanism 602 can be disengaged by, e.g., applying force to the engagement mechanism 602 to bend it aside and allow removal of the light cap 104.

FIG. 6B illustrates an example light cap 104 in accordance with some embodiments described herein. The light cap 104 is made of optically transparent material.

FIG. 7 illustrates an underside of an example bottom plate 116 in accordance with some embodiments. The bottom plate 116 can include a recess 118 (depicted in FIG. 7 as a protrusion as this photograph shows the underside of the bottom plate 116) and through holes 702. In some embodiments, a thickness (or height) of the bottom plate 116 can be in a range of 5 mm to 30 mm. The through holes 702 enable attachment of the bottom plate to the sensor tray 112 and/or to the cover plate 120. The bottom plate 116 can include amorphous or semi-crystalline polymer materials such as polybutylene terephthalate (PBT), polyethylene terephthalate (PET), and these or other polymer materials blended with polycarbonate (PC). In some embodiments, the material can include resin under the trade name of Valox(™).

The recess 118 is sized and shaped to enable the internal block 114 to fit therein. The internal block 114 may be made of metal in some embodiments. A thickness of the internal block 114 can be in a range from 5 mm to 20 mm or can be about 10 mm. The internal block 114 can add additional weight to the eluent level sensor 100 to prevent tipping and increase stability of the eluent level sensor 100.

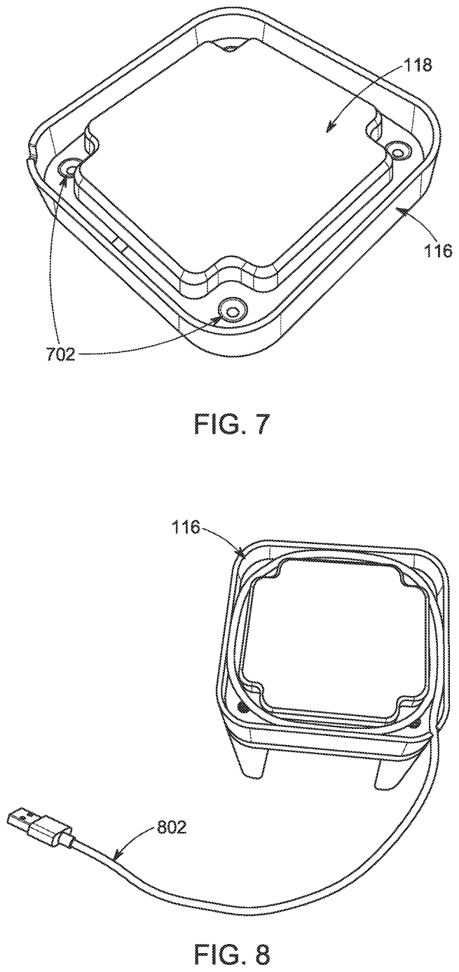

FIG. 8 illustrates an underside of a partially constructed eluent level sensor 100 including the top cover and bottom plate 116. The electrical cable 802 is shown exiting from a cutout in the corner of the bottom plate 116. The electrical cable 802 can wind around the exterior of the recess 118 (again shown from the underside and appearing as a protrusion) to enable storage of excess lengths of electrical cable 802 and to provide strain relief to avoid transmitting force from the electrical cable to internal components such as the circuit board 124.

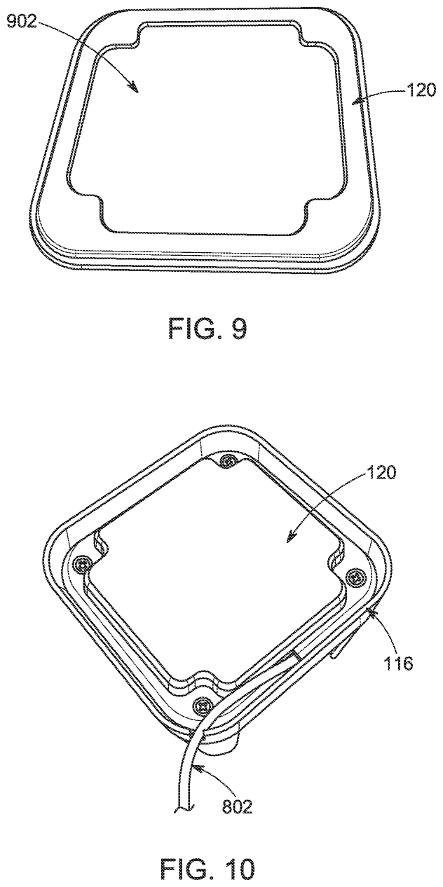

FIG. 9 illustrates an example cover plate 120 in accordance with some embodiments taught herein. The cover plate 120 includes a recess 902 into which the protruding recess 118 of the bottom plate 116 fits. The cover plate 120 can be formed of a material with a high coefficient of friction and/or a material that is electrically insulating and/or a material that is waterproof or water-repellant in various embodiments. The cover plate can be formed of rubber or silicone in some embodiments. In some embodiments, the cover plate 120 is formed by a molding or extrusion process.

FIG. 10 illustrates the underside of the assembled eluent level sensor 100 according to some embodiments taught herein. The cover plate 120 can cover the excess electrical cable 802 and hold it within the eluent level sensor 100 so that the excess cable does not interfere with the stability of the eluent level sensor 100.

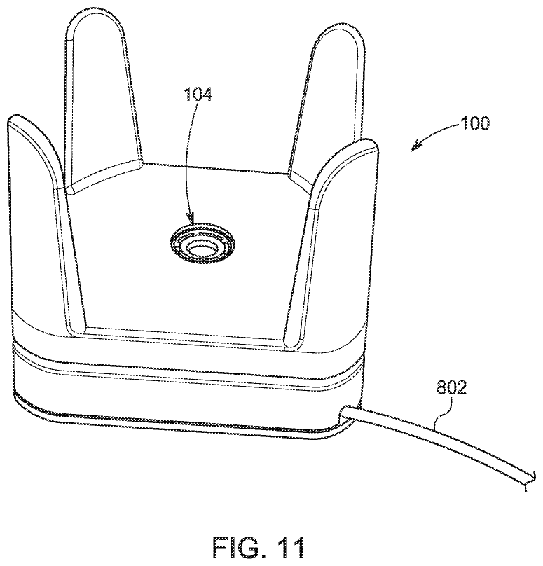

FIG. 11 illustrates the assembled eluent level sensor 100 including light cap 104.

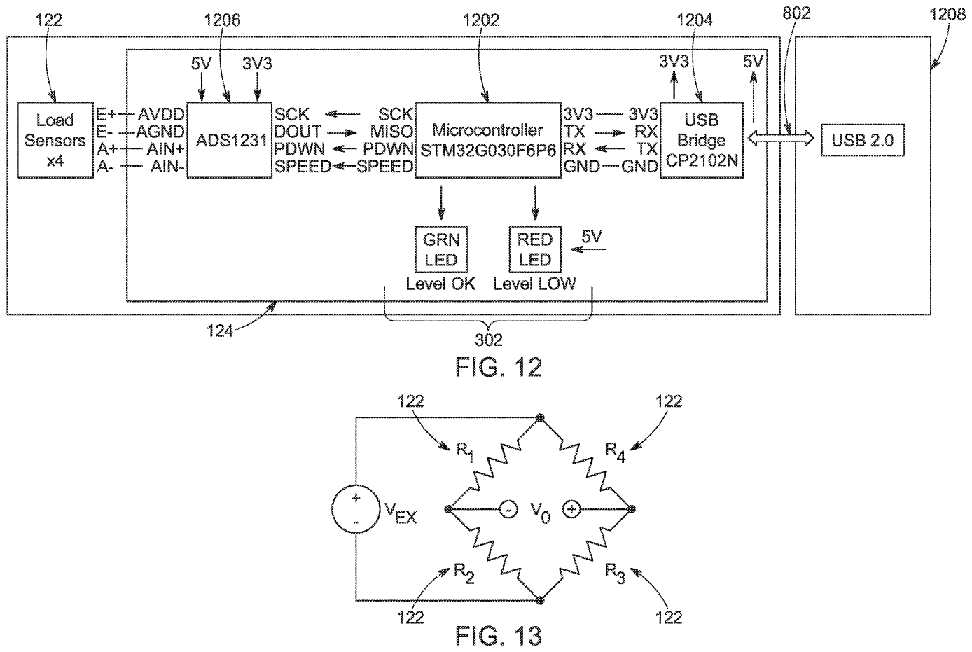

FIG. 12 illustrates an example electrical connection diagram for the eluent level sensor 100 according to some embodiments taught herein. The sensor 122 connects to the circuit board 124 and transmit signals (e.g., changing or constant current or voltage or other signals indicative of resistance, capacitance, or impedance) that are proportional to the physical load measured by the sensor. Specifically, the sensor 122 can communicate signals to an analog-to-digital converter (ADC) 1206 on the circuit board 124. In some embodiments, the ADC 1206 collects the voltage levels from the load sensors. The ADC 1206 then converts the analog voltages received from the sensors 122 to digital format and sends the digital signal to a microcontroller 1202. The communication between ADC 1206 and microcontroller 1202 can be performed using a serial protocol in some embodiments.

The microcontroller 1202 receives the signals from the sensors 122 via the ADC 1206 and processes the signals to convert digital counts from the ADC 1206 to a corresponding liquid level.

The microcontroller 1202 can compare the determined liquid level to the predetermined threshold. If the liquid level should be above the threshold (i.e., for measurements of containers at the input to the instrument) but the liquid level is, in fact, below the threshold, the microcontroller 1202 can set an “alert” status. Likewise, if the liquid level should be below the threshold (i.e., for measurement of waste fluid) but the liquid level is, in fact, above the threshold, the microcontroller 1202 can set an “alert” status. If the liquid level is within tolerance, the microcontroller 1202 can set a “ready” status.

In response to the system status being “ready,” the microcontroller 1202 can control the visual indicator 302 to indicate that no action is needed from the user (e.g., lighting a green LED). In response to the system status being “alert,” the microcontroller 1202 can control the visual indicator 302 to indicate that action is needed from the user (e.g., lighting a red LED).

The microcontroller 1202 can also send communications to an external computing device 1208 to inform the external computing device as to whether the eluent level sensor 100 is at “ready” or “alert” status. In some embodiments, the microcontroller 1202 sends signals to a USB bridge 1204. The USB bridge 1204 encodes, packetizes, or otherwise prepares to send the signal information from the microcontroller 1202 to the external computing device 1208 via the electrical cable 802 or wirelessly. The microcontroller 1202 can send binary status information (i.e., “ready” vs. “alert”) in some embodiments. In some embodiments, the microcontroller 1202 can send additionally or alternatively the raw sensor data or raw digital signals representative of the liquid level in the container to the external computing device 1208.

The external computing device 1208 can include a display to provide graphical indications on-screen of the ready or alert status of the eluent level sensor 100. In addition, the external computing device 1208 can include a memory holding instructions to take action based upon the ready or alert status of the eluent level sensor 100. For example, the external computing device 1208 can interrupt or prevent operation of an associated chromatography instrument if the liquid level in the container is insufficient to enable proper operation of the chromatography instrument. Such a shutdown or prevention operation can prevent damage to the chromatography instrument that can occur if the pumps are forced to operate in low-or no-flow conditions. Similarly, stopping operation of the associated chromatography instrument when the waste container is near overflowing can prevent spills. Thus, alert warnings not only help the user to refill/unload the containers but also prolongs the life of subsidiary parts in the flow path like pumps, columns, etc.

In some embodiments, the microcontroller 1202 can incorporate or be in communication with a volatile or non-volatile memory storing parameters to enable conversion of signals from sensors 122 to measurements of liquid level. One or more parameters can be used in the calculation of liquid levels based on measured sensor signals. In some embodiments, the microcontroller 1202 can sense the weight of the container with contained eluent based on signals from the sensors 122. The microcontroller 1202 can compare the sensed weight to a known weight for the type of container stored in the memory. When the sensed weight approaches the known weight (i.e., as the liquid level threshold is approached), the microcontroller 1202 can indicate an alert status because the container is nearly empty. In other embodiments, the memory can store specific gravity values associated with different liquids in a look-up table or based on user input values (for example, values input by a user at the external computing device). In some embodiments, the memory can store the threshold value to which liquid levels are compared. In some embodiments, the memory can store expected weights for different full container types, empty container types, or both. In some embodiments, the memory can store information about the elevation (above sea level) of the location of the eluent level sensor 100 to improve precision in the weight measurements. The information in the memory can be updated by the user and/or by the external computing device 1208. In some embodiments, the eluent level sensor can be a “plug and play” style device wherein the eluent level sensor can operate without initial manual configuration. For example, the microcontroller 1202 and/or memory can store previously set parameters including bottle type, eluent type, and/or threshold levels and can uses the stored parameters for subsequent runs.

In some embodiments, the microcontroller 1202 or external computing device can use information from the sensors to determine whether to allow future experimental runs to proceed. When the user initiates a single or multiple set of chromatographic runs, the external computing device and/or microcontroller 1202 can identify and pre-alert the user if sufficient fluid source volumes are present to complete the full series of runs and/or if the waste volume is presently too much to accommodate the additional waste that would be generated by the runs. For example, the external computing device can notify the microcontroller 1202 that the user wishes to do one or more experimental runs. The microcontroller 1202 can provide an estimate of the remaining volume of source eluent or the remaining empty volume in the waste container. In some embodiments, the microcontroller 1202 can also provide an estimated use rate (i.e., rate at which the waste bottle is filling during a run or rate that the source bottle is emptying during a run), or the external computing device can determine this information from signals provided from the microcontroller. The external computing device can then notify the user to take action to fill/empty containers until a sufficient supply of source fluid or empty waste volume is available to accommodate the full series of runs planned by the user. The eluent level sensor can also supply the use rate to the user upon request. In some embodiments, the user can propose parameters for an experimental run and the eluent level sensor can provide an estimate for the amount of source fluid that would be needed and/or amount of waste that would be generated by such a proposed experimental run in a predictive manner.

In some embodiments, the circuit board 124 can include a wireless communication circuit that uses active or passive electronic protocols to communicate with nearby objects. For example, the wireless communication circuit could be a radio-frequency (RF) tag reader or other near-field communication reader or a Bluetooth(R) or Wi-Fi communication module. The wireless communication circuit can be connected to the microcontroller 1202 and can be used for automatic identification of containers that include a tag or transmitter adapted to communicate with the near-field communication circuit. The information received by the wireless communication circuit from the container can include one or more of an identity of the container, specification of a size or shape of the container, specification of the type of liquid within the container, or specification of density or specific gravity of the fluid in the container. Based upon the received information, the microcontroller 1202 can automatically set parameters including the type and size of the bottle and even any assigned fluid type. For example, the microcontroller 1202 can access known container weight values from the memory that are associated with the type of container as identified by information from the communication circuit. This information can then be stored in the memory and used to convert measured signals from the sensors into liquid weight, level, or volume information in some embodiments.

In some embodiments, the external computing device can continuously ping the microcontroller 1202 for the level information and the status with respect to the set threshold. Although the physical electrical layer for communication between the eluent level sensor and the external computing device can be universal serial bus (USB), the communication protocol can include custom or proprietary commands in some embodiments.

In some embodiments, the sensors 122 are of a type known as strain gauge load cells. Strain gauge load cells can be found in industrial settings. Strain gauge load cells can be highly accurate, versatile, and cost-effective. Structurally, this type of sensor has a metal body to which strain gauges have been secured. The body is usually made of aluminum, alloy steel, or stainless steel which makes it very sturdy but also minimally elastic. This elasticity gives rise to the term “spring element”, referring to the body of the load cell. When force is exerted on the load cell, the spring element is slightly deformed, and unless overloaded, returns to its original shape. As the spring element deforms, the strain gauges also change shape. The resulting alteration to the resistance in the strain gauge can be measured as voltage. The change in voltage is proportional to the amount of force applied to the cell, thus the amount of force can be calculated from the load cell's output.

In some embodiments, the change in resistance measured by a single strain gauge sensor can be extremely small such that it is difficult to accurately measure changes. Increasing the number of strain gauges applied collectively can magnify these small changes into something more measurable. FIG. 13 illustrates a schematic view of electrical connections between four sensors 122 in some embodiments taught herein. The four sensors 122 can be arranged as a Wheatstone bridge. The Wheatstone bridge is a configuration of four balanced resistors with a known excitation voltage applied as shown in FIG. 13.

In some embodiments, the basic principle of operation is that the weight of the eluent along with the container is measured by the 4 load cell sensors placed in the Wheatstone bridge arrangement. These are strain gauges that change their resistances when there is deflection due to strain. This change is resistance is measured as a change in voltage by the ADC 1206 on the circuit board 124. The ADC 1206 is connected to the microcontroller 1202 which takes the output from the ADC 1206 and calculates the level depending on the parameters set by the user. The microcontroller 1202 can also control the visual indicator 302 such as a green LED when the liquid is above the threshold level (in eluent delivery systems) or below the threshold level (in eluent waste system). This indicates to the user that the liquid level is well above\below the set threshold. Whenever the liquid level crosses or passes the threshold level, the microcontroller 1202 can control the visual indicator 302 to change, e.g., changing the green LED color to red. This helps the user to easily locate the container that needs a refill (in eluent delivery systems) or that needs to be emptied (in eluent waste systems).

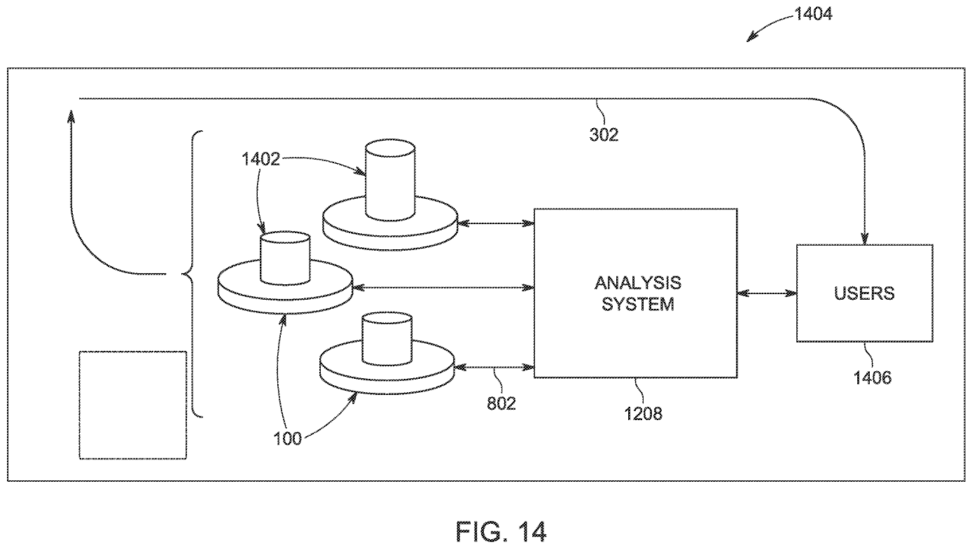

FIG. 14 illustrates a networked sensing environment 1404 that includes multiple eluent level sensors 100 connected to an external computing device 1208 in the form of an analysis system in accordance with some embodiments taught herein. While the figures shows the eluent level sensors 100 all connected through electrical cables 802, the present disclosure is not limited to such an arrangement and the eluent level sensors 100 can be connected by other means including through wireless connection (e.g., Bluetooth(R) or Wi-Fi) or through intermediary networks or network protocols (e.g., through a local area network or through the internet).

In some embodiments, the number of sensors 122 in a range of sizes that are connected to a single external computing device 1208 (e.g., analysis system) can be as high as 256. Once a user 1406 sets the parameters for each sensor module (e.g., container type, fluid type, initial fill level), the analysis system tracks the level of the liquid in each container associated with the sensors. Users 1406 can access the external computing device 1208 to monitor the statuses of the entire of array of eluent level sensors 100 at a glance.

Users 1406 can also use the external computing device to add or change parameters in the memory of one or more of the eluent level sensors 100. In some embodiments, users 1406 can use control programs on the external computing device or other connected devices that control associated chromatography instruments to take actions based upon the status of the eluent level sensor such as pausing operation to allow for replenishment of liquids.

The visual indicators 302 of each eluent level sensor 100 in the networked sensing environment 1404 can provide immediate and targeted information to the system users 1406. In other words, the eluent level sensors can assist a user to monitor multiple containers placed at different locations in their laboratory/work area. In a large laboratory with many operating chromatography instruments, it can be difficult conventionally for a user to pinpoint which container in the system is causing an alert status. For example, a user of a conventional system may need to rely upon ID or barcode identifiers given by a computing device and have to hunt through the laboratory to compare this information to identifiers on each individual container. The use of visual indicators 302 as taught herein enables the user to immediately determine by sight the location of the eluent level sensor 100 in the networked sensing environment 1404 that has shown an alert status.

In some embodiments, the external computing device 1208 can utilize the sensor data to pre-alert the user and/or associated systems of available liquid capacities or give regular feedback during operation. The eluent level sensor 100 can constantly communicate with the external computing device 1208 to give the information and alerts regarding the volume or level of the liquid.

In some embodiments, the microcontroller 1202 or external computing device 1208 can transmit tracking data specific to particular eluent level sensors or containers to Cloud Management database systems for lab information management. This communication would assist in tracking the location of containers within a lab or facility and could enable efficient re-ordering of new containers or eluent liquid when it is determined that liquid levels are low in particular containers and/or that a set number of alerts have occurred, which indicates that a certain amount of eluent stock has been used up.

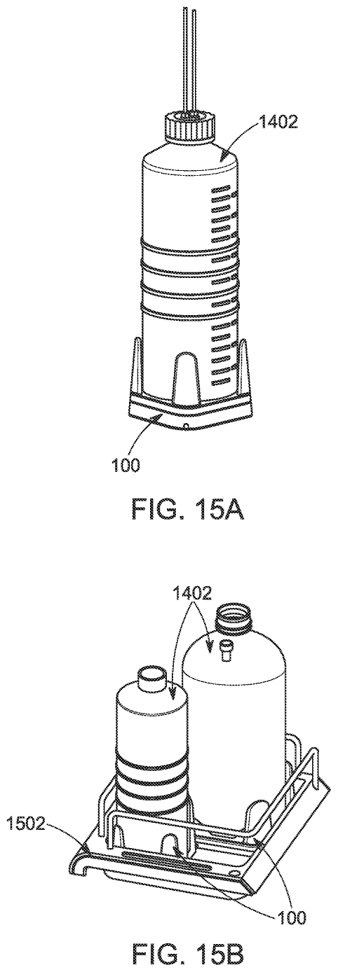

FIG. 15A illustrates embodiments of eluent level sensors 100 as taught herein holding containers 1402. In some embodiments, the eluent level sensor 100 can be sized or shaped to hold a specific or pre-determined size or shape container. For example, the eluent level sensor can be sized to support a 1-liter, 2-liter, 4-liter, or other appropriately sized container whether cylindrical, rectangular, prismatic, or other shape. In other embodiments, the eluent level sensor can be designed to fit a range of container sizes. For example, the corner guides may be extendible in some embodiments to enable stabilization of taller containers. Similarly, the top cover may have extension elements that enable increase in length or width of a footprint of the eluent level sensor.

FIG. 15B illustrates two eluent level sensors 100 that are stored in an instrument tray 1502 for a chromatography instrument. The instrument tray 1502 can advantageously be a removable portion of the chromatography instrument that includes handles to make user manipulation easier and enable the user to get a solid grip upon the instrument tray 1502. In some embodiments, the instrument tray 1502 is placed on top of a cabinet or rack of the chromatography instrument. In other embodiments, the instrument tray 1502 or single eluent level sensors 100 can be located remotely to (i.e., not in contact with) the chromatography instrument such as on the floor or other work surface. In this sense, the systems and methods described herein can differ from some conventional systems where the containers can only be placed atop the chromatography instrument itself and may not be placed elsewhere. Whether placed on the top of the instrument, adjacent to the instrument, or remotely, the eluent level sensors taught herein can be modular and can be placed anywhere for general use with analytical instruments such as chromatography instruments. As a portable device, the eluent level sensor can be placed on the instrument or on a lab table. This gives flexibility to the user to place multiple containers in any surrounding location.

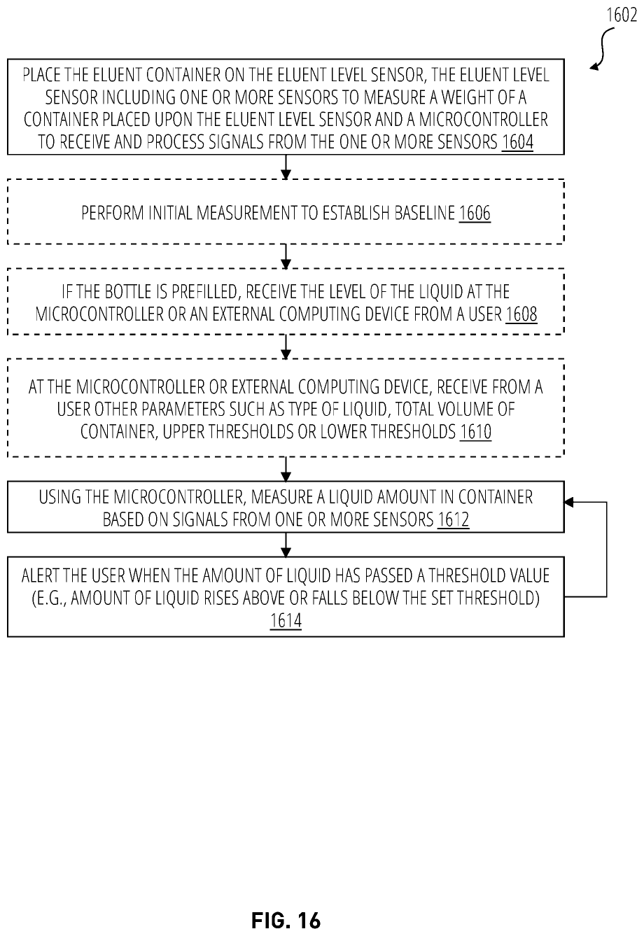

FIG. 16 illustrates a flowchart for a method 1602 of automatically measuring liquid levels in a container for use with chromatography systems. In this method, one eluent level sensor 100 is considered, but the person of ordinary skill in the art would understand that more than one eluent level sensor 100 may be involved in the system. At block 1604, the container is placed on the eluent level sensor 100. For example, the container can be placed on the top cover 102 and be held in place by corner guides 108. This container can be a bottle that serves the eluent to the system for analysis or a bottle that collects the waste or used eluent. At optional block 1606, the method 1602 can perform an initial measurement before eluent removal or addition begins to establish a baseline. The microcontroller and/or external computing device can use the baseline to remove the effect of the container and tubing on subsequent measurements (e.g., by subtracting the baseline value). For example, the user can initialize the eluent level sensor (e.g., tare) based on the empty container before filling the container with eluent (in the case where the container is collecting waste eluent). Alternatively or in addition, initialization can include setting the threshold based on the initial measurement of the weight. For example, the eluent level sensor can compare the initial measurement to data on full containers stored in the memory to determine where the threshold should be set. At optional block 1608, the user can enter an approximate existing volume if there is any liquid prefilled in the container before the measurement starts. The level of liquid can be received from the user by the microcontroller and/or the external computing device. This helps the eluent level sensor to make and track an accurate measurement. At optional block 1610, the microcontroller or external computing device can receive additional parameters from the user such as information as to whether the container is one of the predefined bottles about which information is stored in memory or whether the container is a custom bottle. The user can modify the parameters accessible to the microcontroller 1202 of the eluent level sensor 100 such as type of liquid, total available volume of the container, user-specified upper threshold volume, or user-specified lower threshold volume. When a custom bottle is selected at block 1606 or block 1610, variations in the tubing, fittings and ferrules can even be accounted for during subsequent measurements. This helps the user get more accurate and realistic fluid data from the eluent level sensor.

At block 1610, the user can also enter and record notes like name and type of liquid into the external computing device (e.g., through a graphical user interface) or microcontroller. Control variables can be retained in the memory and can include high/low thresholds and visual indicator brightness levels. When a custom bottle is used, the user can also provide the expected maximum volume of the bottle. At block 1612, the eluent level sensor can measure the liquid level in the container using one or more sensors. For example, the eluent level sensor can determine a difference in weight between current measurements, initial measurements, or values computed or stored in the memory. The eluent level sensor 100 can communicate measurements constantly by transferring information to the external computing device. The external computing device or microcontroller can display the status of the changing eluents in the containers continuously in some examples. When the amount of liquid (e.g., eluent, precursors, or waste) passes a threshold value (e.g., amount rises above or falls below threshold as appropriate for the operation whether for full or waste containers), the user is alerted (block 1614). For example, the external computing device can deploy a visual indicator on the graphical user interface. Similarly, the eluent level sensor itself can activate or modify a visual indicator on the body of the unit itself to alert the user. For example, the eluent level sensor can change a light intensity or a color of light emitted through a light cap and through the transparent container (or beneath the container if it is too opaque to pass the indicator light). Additionally, related actions can be performed such as forced shutdown of a fluid pump (to prevent damage due to dry running) immediately or after a delay during which the user fails to take action. Block 1612 and block 1614 can repeat iteratively over time as the eluent level sensor continuously monitors the liquid level in the container and sends further alerts to the user if conditions change (i.e., change light properties or indicator status after the alert condition is addressed by the user and “ready” status is achieved).

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

The embodiments described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The embodiments, described herein, also relate to a device or an apparatus for performing these operations. The systems and methods described herein can be specially constructed for the specific purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the specific operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Advantages and features of the present disclosure can be further described by the following examples:

Example 1. An eluent level sensor, comprising: one or more sensors to measure a weight of a container placed upon the eluent level sensor; a microcontroller to receive and process signals from the one or more sensors, the microcontroller configured to set an alert status if the signals from the one or more sensors indicate that an amount of liquid in the container has passed a threshold value.

Example 2. The eluent level sensor of example 1, wherein the microcontroller is configured to process the signals from the one or more sensors to compare a measured weight of the container with a known weight of the container stored in a memory.

Example 3. The eluent level sensor of example 1 or 2, wherein the microcontroller is configured to process the signals from the one more sensors to determine a weight or volume of a liquid in the container using specific gravity values stored in a memory.

Example 4. The eluent level sensor of any one of examples 1 to 3, wherein the liquid is waste eluent and the threshold value is a maximum capacity.

Example 5. The eluent level sensor of any one of examples 1 to 3, wherein the liquid is new eluent or an eluent precursor.

Example 6. The eluent level sensor of example 5, wherein the microcontroller is configured to compare signals from the one or more sensors to signals from sensors corresponding to a waste container to identify a leakage condition.

Example 7. The eluent level sensor of any one of examples 1 to 6, wherein the eluent level sensor is configured to communicate with an external computing device having a graphical user interface configured to enable a user to set the threshold value.

Example 8. The eluent level sensor of any one of examples 1 to 7, further comprising a light cap aligned with a visual indicator to indicate the alert status by light or color visual feedback conveyed through the container.

Example 9. The eluent level sensor of example 7, wherein the light cap is removably engaged with a top cover of the eluent level sensor.

Example 10. The eluent level sensor of any one of examples 1 to 9, wherein the eluent level sensor provides the alert status to an external computing device.

Example 11. The eluent level sensor of any one of examples 1 to 10, wherein the one or more sensors include multiple load cells connected in a style of a Wheatstone bridge.

Example 12. The eluent level sensor of any one of examples 1 to 11, wherein the microcontroller is configured to set a ready status when the amount of liquid has not passed or no longer passes the threshold value.

Example 13. The eluent level sensor of any one of examples 1 to 12, wherein the eluent level sensor is portable, the eluent level sensor can be repositioned after initial placement, or the eluent level sensor can be located apart from a chromatography instrument.

Example 14. The eluent level sensor of any one of examples 1 to 13, further comprising: a top cover to support the container; and a sensor tray including a ridge configured to seal against the top cover to prevent fluid ingress into an interior of the eluent level sensor.

Example 15. The eluent level sensor of example 14, wherein the top cover comprises one or more corner guides that are at least partially hollow and that facilitate positioning of the container atop the top cover.

Example 16. The eluent level sensor of any one of examples 1 to 15, further comprising an internal block to increase stability of the eluent level sensor.

Example 17. The eluent level sensor of any one of examples 1 to 16, wherein the microcontroller is configured to halt operation of a fluid pump when the alert status is set.

Example 18. The eluent level sensor of example 1, wherein the microcontroller determines a use rate of the liquid over time and provides the use rate to a user.

Example 19. The eluent level sensor of any one of examples 1 to 18, further comprising a wireless communication circuit to communicate with a tag or transmitter of the container to determine at least one of an identity of the container, a size of the container, a shape of the container, a type of liquid within the container, or a density or specific gravity of the liquid within the container.

Example 20. A method of automatically measuring a liquid level in a container for use with a chromatography system, the method comprising: placing a container on an eluent level sensor, the eluent level sensor including one or more sensors to measure a weight of a container placed upon the eluent level sensor and a microcontroller to receive and process signals from the one or more sensors; using the microcontroller, measuring a liquid amount in the container based on the signals from the one or more sensors; and alerting a user when the liquid amount has passed a threshold value.

Example 21. The method of example 20, wherein measuring the liquid amount includes comparing a measured weight of the container with a known weight of the container stored in a memory.

Example 22. The method of example 20 or 21, wherein measuring the liquid amount includes processing the signals from the one more sensors to determine a weight or volume of a liquid in the container using specific gravity values stored in a memory.

Example 23. The method of any one of examples 20 to 22, wherein the liquid is waste eluent and the threshold value is a maximum capacity.

Example 24. The method of any one of examples 20 to 22, wherein the liquid is new eluent or an eluent precursor.

Example 25. The method of example 24, further comprising identifying a leakage condition by comparing signals from the one or more sensors to signals from additional sensors corresponding to a waste container.

Example 26. The method of any one of examples 20 to 25, further comprising receiving, from a graphical user interface of an external computing device, the threshold value from a user.

Example 27. The method of any one of examples 20 to 26, wherein alerting the user further comprises changing light intensity or color visual feedback conveyed through the container using a visual indicator aligned with a light cap in the eluent level sensor.

Example 28. The method of example 26, wherein the light cap is removably engaged with a top cover of the eluent level sensor.

Example 29. The method of any one of examples 20 to 28, wherein alerting the user includes providing the alert status to an external computing device.

Example 30. The method of any one of examples 20 to 29, wherein the one or more sensors include multiple load cells connected in a style of a Wheatstone bridge.

Example 31. The method of any one of examples 20 to 30, further comprising setting a ready status when the amount of liquid has not passed or no longer passes the threshold value.

Example 32. The method of any one of examples 20 to 31, further comprising moving the eluent level sensor, repositioning the eluent level sensor after initial placement, or locating the eluent level sensor apart from a chromatography instrument.

Example 33. The method of any one of examples 20 to 32, wherein placing the eluent container includes placing the container on a top cover of the eluent level sensor to support the container, the method further comprising: sealing a ridge of a sensor tray against the top cover to prevent fluid ingress into an interior of the eluent level sensor.

Example 34. The method of example 33, wherein placing the eluent container includes holding the container using one or more corner guides of the top cover that are at least partially hollow.

Example 35. The method of any one of examples 20 to 34, wherein the eluent level sensor further comprises an internal block to increase stability of the eluent level sensor.

Example 36. The method of any one of examples 20 to 35, further comprising halting operation of a fluid pump subsequent to alerting the user.

Example 37. The method of any one of examples 20 to 36, further comprising determining a use rate of the liquid over time and providing the use rate to a user.

Example 38. The method of any one of examples 20 to 37, further comprising communicating, using a wireless communication circuit, with a tag or transmitter of the container to determine at least one of an identity of the container, a size of the container, a shape of the container, a type of liquid within the container, or a density or specific gravity of the liquid within the container.

1. An eluent level sensor, comprising:
one or more sensors to measure a weight of a container placed upon the eluent level sensor;
a microcontroller to receive and process signals from the one or more sensors, the microcontroller configured to set an alert status if the signals from the one or more sensors indicate that an amount of liquid in the container has passed a threshold value.

2. The eluent level sensor of claim 1, wherein the microcontroller is configured to process the signals from the one or more sensors to compare a measured weight of the container with a known weight of the container stored in a memory.

3. The eluent level sensor of claim 1 or 2, wherein the microcontroller is configured to process the signals from the one more sensors to determine a weight or volume of a liquid in the container using specific gravity values stored in a memory.

4. The eluent level sensor of any one of claims 1 to 3, wherein the liquid is waste eluent and the threshold value is a maximum capacity.

5. The eluent level sensor of any one of claims 1 to 3, wherein the liquid is new eluent or an eluent precursor.

6. The eluent level sensor of claim 5, wherein the microcontroller is configured to compare signals from the one or more sensors to signals from sensors corresponding to a waste container to identify a leakage condition.

7. The eluent level sensor of any one of claims 1 to 6, wherein the eluent level sensor is configured to communicate with an external computing device having a graphical user interface configured to enable a user to set the threshold value.

8. The eluent level sensor of any one of claims 1 to 7, further comprising a light cap aligned with a visual indicator to indicate the alert status by light or color visual feedback conveyed through the container.

9. The eluent level sensor of claim 7, wherein the light cap is removably engaged with a top cover of the eluent level sensor.

10. The eluent level sensor of any one of claims 1 to 9, wherein the eluent level sensor provides the alert status to an external computing device.

11. The eluent level sensor of any one of claims 1 to 10, wherein the one or more sensors include multiple load cells connected in a style of a Wheatstone bridge.

12. The eluent level sensor of any one of claims 1 to 11, wherein the microcontroller is configured to set a ready status when the amount of liquid has not passed or no longer passes the threshold value.

13. The eluent level sensor of any one of claims 1 to 12, wherein the eluent level sensor is portable, the eluent level sensor can be repositioned after initial placement, or the eluent level sensor can be located apart from a chromatography instrument.

14. The eluent level sensor of any one of claims 1 to 13, further comprising:
a top cover to support the container; and
a sensor tray including a ridge configured to seal against the top cover to prevent fluid ingress into an interior of the eluent level sensor.

15. The eluent level sensor of claim 14, wherein the top cover comprises one or more corner guides that are at least partially hollow and that facilitate positioning of the container atop the top cover.

16. The eluent level sensor of any one of claims 1 to 15, further comprising an internal block to increase stability of the eluent level sensor.

17. The eluent level sensor of any one of claims 1 to 16, wherein the microcontroller is configured to halt operation of a fluid pump when the alert status is set.

18. The eluent level sensor of claim 1, wherein the microcontroller determines a use rate of the liquid over time and provides the use rate to a user.

19. The eluent level sensor of any one of claims 1 to 18, further comprising a wireless communication circuit to communicate with a tag or transmitter of the container to determine at least one of an identity of the container, a size of the container, a shape of the container, a type of liquid within the container, or a density or specific gravity of the liquid within the container.

20. A method of automatically measuring a liquid level in a container for use with a chromatography system, the method comprising:
placing a container on an eluent level sensor, the eluent level sensor including one or more sensors to measure a weight of a container placed upon the eluent level sensor and a microcontroller to receive and process signals from the one or more sensors;
using the microcontroller, measuring a liquid amount in the container based on the signals from the one or more sensors; and
alerting a user when the liquid amount has passed a threshold value.

21-38. (canceled)
